(19) United States
(12) Patent Application Publication
(10) Pub. No.: US 2011/0210484 A1
(43) Pub. Date: Sep. 1, 2011

(54) COOLING PLATE FOR A METALLURGICAL FURNACE AND ITS METHOD OF MANUFACTURING

(75) Inventors: Emile Lonardi, Bascharage (LU); Nicolas Mousel, Dudelange (LU); Claude Pleimelding, Platen (LU); Nicolas Maggioli, Thionville (FR)

(73) Assignee: PAUL WURTH S.A., Luxembourg (LU)

(21) Appl. No.: 13/127,480

(22) PCT Filed: Nov. 3, 2009
(86) PCT No.: PCT/EP2009/064557

§ 371 Date: May 4, 2011

(30) Foreign Application Priority Data
Nov. 4, 2008 (LU) 91494

(51) Int. Cl. F27D 1/12; F28F 3/12; B23P 17/00

(52) U.S. Cl. 266/241; 165/170; 29/527.6

(57) ABSTRACT

A cooling plate for a metallurgical furnace includes a body with a front face, an opposite rear face (16), four side edges and at least one coolant channel extending from the region of one side edge to the region of the opposite side edge, where a bent connection pipe connects at least one extremity of each coolant channel for coolant fluid feed or return, and the bent connection pipe is sealingly connected with the extremity of the associated coolant channel within a respective recess in the body that is opened toward the rear side, where the coolant channel opens in the recess in a connection surface beveled towards the rear side; and the bent connection pipe does not extend laterally beyond the corresponding side edge.

### TECHNICAL FIELD

The present invention generally relates to a cooling plate for a metallurgical furnace and its method of manufacturing.

### BACKGROUND

Cooling plates for metallurgical furnaces, also called staves, are well known in the art. They are used to cover the inner wall of the outer shell of the metallurgical furnace, as e.g. a blast furnace or electric arc furnace, to provide: (1) a heat evacuating protection screen between the interior of the furnace and the outer furnace shell; and (2) an anchoring means for a refractory brick lining, a refractory guniting or a process generated accretion layer inside the furnace. Originally, the cooling plates have been cast iron plates with cooling pipes cast therein. As an alternative to cast iron staves, copper staves have been developed. Nowadays, most cooling plates for metallurgical furnaces are made of copper, a copper alloy or, more recently, of steel.

Different production methods have been proposed for copper stave coolers. Initially, an attempt was made to produce copper staves by casting in moulds, the internal coolant channels being formed by a sand core in the casting mould. However, this method has not proved to be effective in practice, because the cast copper plate bodies often have cavities and porosities, which have an extremely negative effect on the life of the plate bodies. The mould sand is difficult to remove from the channels and the channels are often not properly formed.

A cooling plate made from a forged or rolled copper slab is known from DE 2 907 511 C2. The coolant channels are blind boreholes introduced by deep drilling the rolled copper slab. The blind boreholes are sealed off by welding-in plugs. Then, connecting bores are drilled from the rear side of the plate body into the blind boreholes. Thereafter, connection pipe-ends for the coolant feed or coolant return are inserted into these connecting bores and welded to the stave body. With these cooling plates, the above-mentioned disadvantages related to casting are avoided. In particular, cavities and porosities in the plate body are virtually precluded. The above manufacturing method is however relatively expensive both in labour and material.

WO 2004/090172 discloses a cooled furnace shell for a metallurgical furnace, wherein adjacent cooling plates are interconnected through a common opening in the furnace shell. Therefore, the connecting piece, that take the form of e.g. bent tubes, are connected to the side edges of the cooling plate body, in communication with the internal coolant channels. Hence, the connection pieces form a kind of axial extension of the respective coolant channels through the edge faces of the cooling plate body. The fact that the bent tubes protrude laterally from the side edges facilitates the interconnection of the bent tubes from adjacent cooling plates through the opening in the furnace shell. The facing side edges of adjacent cooling plates from which the bent tubes protrude may be beveled in mirror-image fashion toward the inner side of the furnace, so that they delimit a wedge-shaped space shielding the connecting pieces from thermal radiation from the furnace. Such arrangement of the cooling plates in the furnace shell, which requires a particular design of the cooling plates with laterally protruding connection pieces, is peculiar and not always desirable.

### BRIEF SUMMARY

The invention provides a simple method of manufacturing a cooling plate for a metallurgical furnace that provides reliable cooling plates of wide applicability.

A method for manufacturing a cooling plate for a metallurgical furnace in accordance with the present invention comprises the steps of: providing a slab body of metallic material having at least one coolant channel therein; and machining the body so that at least one extremity of each coolant channel opens in a connection surface inside a respective recess open toward the rear face, the connection surface being beveled towards the rear face. A bent connection pipe is then sealingly connected with the extremity of the coolant channel in the recess, wherein the bent connection pipe does not extend laterally beyond the side edge.

As compared to the prior art method described e.g. in DE 2 907 511 C2, with the present method it is no longer necessary to seal off the opening to the coolant channels in the side edges where it has been drilled, by welding in-a plug. The bent connection pipes are directly connected with the coolant channels inside the respective recesses. These recesses further act as protection for the connection pipes in the region of their connection to the cooling plate. This is also in contrast with the cooling plates of WO 2004/090172, wherein the connection pipes protrude laterally from and beyond the side edges and the whole side edge is bevelled to provide protection, however by cooperating with the adjacent cooling panel.

Furthermore, the bevelled connection surface in the recess may reduce the bend angle in the bent connection pipe, thereby facilitating manufacturing thereof and connection. The angle between the connection surface and rear face of the body may be between 20 and 70°, preferably between 30° and 50°, more preferably about 45°. Accordingly, the bend angle of the connection pipe may be between 110° and 160°. The connecting end of the connection may be shaped as desired to adapt to the angle of the connecting surface and section of the coolant channel opening therein.

Hence, the present invention provides a simple method of manufacturing cooling plates with connection pipes protruding from the rear face, allowing for a traditional manner of connecting and installing the cooling plates in the metallurgical furnace.

It may further be noted that the absence of the plug (for closing the drilling hole) provides a more reliable cooling plate. Indeed, as the cooling plate is exposed to considerable mechanical and thermal stress, in particular in the edge regions of the cooling plate, the plug has to be considered as a weak point. If the weld of the plug deteriorates, fluid tightness of the cooling channel can no longer be guaranteed and coolant could leak from the cooling channel into the furnace.

Preferably, the coolant channels are formed into the body by drilling. In one embodiment, the at least one coolant channel is formed by drilling at least one borehole into the body from a first side edge toward the opposite second side edge. This borehole may be a blind hole or through hole, the latter simplifying cleaning of the drilled cooling channel. In both cases a connection pipe may be connected on the drilling edge side (where the drill-bit enters the body) and on the opposite edge side, since the respective recess is typically formed in axial continuation of the coolant channel. Accordingly, in one variant, the cooling plate comprises a plurality of parallel coolant channels provided each with a pair of connection pipes (one in each opposite side edge region).

In another embodiment, connection pipes are only arranged on one side edge, whereby the inlet and outlet of a coolant channel are situated on the same side edge. Accordingly, the method may comprise the steps of providing the slab with a first cooling channel by drilling a first blind borehole into the slab, wherein the first blind borehole is drilled from the first edge towards the opposite second edge; and providing the slab with a second cooling channel by drilling a second blind borehole into the slab, wherein the second blind borehole is drilled from the first edge towards the second edge. The first and second cooling channels are arranged in such a way that their ends in a second edge region meet and form a fluid communication between the first and second cooling channels. For example, the first and second blind boreholes may be both drilled from the first edge towards the second edge at an angle with respect to each other, in such a way that their ends meet in the second edge region. The resulting first and second cooling channels thereby form a combined “V”-shaped cooling channel, wherein coolant flows through one of the cooling channels towards the second edge region and then, through the other one of the cooling channels, back to the first edge region.

In a further variant, the method may comprise the steps of providing the slab with a first cooling channel by drilling a first blind borehole into the slab, wherein the first blind borehole is drilled from a first edge towards the opposite second edge, wherein an end of the first blind borehole is arranged in a second edge region of the slab. The extremity of the cooling channel in the first side edge region is then connected via a bent pipe in a recess as mentioned above, whereas the connection to the coolant channel in the second edge region is carried out by drilling a connecting bore extending from the rear face of the slab to the end of the first blind borehole.

As to the fixation of the bent connection pipes, each connection pipe may be soldered or welded around the corresponding coolant channel opening in the respective connection surface. For ease of connection, a centering sink surrounding the channel opening may be provided in the connection surface.

The method preferably comprises the additional step of forming grooves and intermittent lamellar ribs in the front face of the panel-like body for anchoring a refractory brick lining or the like. To warrant a good anchoring function of the lamellar ribs and grooves structure on the front face of the cooling plate and a good thermal form stability of the cooling plate, the grooves are advantageously formed with a width that is narrower at an inlet of the groove than at a base of the groove. The grooves may e.g. be formed with dovetail cross-section.

Preferably, the cooling plate body is made of at least one of the following materials: copper, a copper alloy or steel.

Optionally, the stave body with the coolant channels therein may have been subjected to a rolling step to form coolant channels with oblong cross-section.

According to another aspect of the present invention there is proposed a cooling plate manufactured by the above method and which provides the described advantages as compared to known staves.

### BRIEF DESCRIPTION OF THE DRAWINGS

Preferred embodiments of the invention will now be described, by way of example, with reference to the accompanying drawings, in which:

FIG. 1: is a perspective view of a preferred embodiment of the present cooling plate, seen from the rear face;

FIG. 2 is a cross-sectional view illustrating the connection pipe to slab connection within one recess;

FIG. 3 is a rear view of the cooling plate of FIG. 1;

FIG. 4 is a side view of the cooling plate of FIG. 1.

FIG. 5 is a rear view of another embodiment of the present cooling plate; and

FIG. 6: is a rear view of a further embodiment of the present cooling plate.

### DETAILED DESCRIPTION

Cooling plates are used to cover the inner wall of an outer shell of a metallurgical furnace, as e.g. a blast furnace or electric arc furnace. The object of such cooling plates is to form: (1) a heat evacuating protection screen between the interior of the furnace and the outer furnace shell; and (2) an anchoring means for a refractory brick lining, a refractory guniting or a process generated accretion layer inside the furnace.

A preferred embodiment of the present cooling plate 10 is illustrated in detail in the Figures. The cooling plate 10 is typically formed from a slab e.g. made of a cast or forged body of copper, copper alloy or steel into a panel-like body 12. This panel-like body 12 has a front face 14, also referred to as hot face, which will be facing the interior of the furnace, and a rear face 16, also referred to as cold face, which will be facing the inner surface of the furnace wall. Conventionally, the panel-like body 12 generally has the form of a quadrilateral with a pair of long side edges 18, 18′ and a pair of short side edges 20, 20′. Most modern cooling plates have a width in the range of 600 to 1300 mm and a height in the range of 1000 to 4200 mm. It will however be understood that the height and width of the cooling plate may be adapted, amongst others, to structural conditions of a metallurgical furnace and to constraints resulting from their fabrication process.

The cooling plate 10 further comprises bent connection pipes 26, 28 for feed and return of cooling fluid, generally water. These connection pipes 26, 28 are connected from the rear side of the panel-like body 12 to cooling channels 30 arranged within the panel-like body 12. As it will be understood from the Figs., these coolant channels 30 extend through the body 12 in proximity of the rear face 16, from about one short side edge 20 to the opposite one 20′ (as represented by the mixed lines 30). In the present embodiment, each coolant channel 30 is provided at both extremities with an appropriate bent connection pipe 26 and 28, through which the coolant fluid is fed into the respective cooling channel 30 and/or through which the cooling fluid leaves the coolant channel 30.

It will be appreciated that the extremity of each channel opens into an individual recess 32 that is open towards the rear face 16, and more specifically in a connection surface 34 thereof that is beleved towards the rear face 16. The angle α between the connection surface and the rear face may be between 20° and 70°, preferably between 30° and 50°, more preferably about 45°. The connection pipes 26 and 28 are in sealed communication with the extremities of the channels 30. The pipe ends may typically be welded or soldered around the channel's 30 opening in the connection surface 34.

This beveled connection surface 34 is appreciable in that it reduces, in the present variant, the bend in the connection pipe 26 or 28, as compared to a 90°-bend (which is however also an alternative). It may be noted that the coolant channels 30 may be circular or oblong in cross-section. The end of the connection pipe 26, 28 is thus adapted to the shape of the channel opening in the connection surface 34.

It is further to be appreciated that the bent connection pipes 26, 28 do not extend laterally beyond the side edge in the region where they are installed. Accordingly, the position of the recess 32, and more specifically of the connection surface 34 as well as the dimension and shape of the connection pipe 26, 28 are selected so that the connection pipes 26, 28 remain within the perimeter of the front face of the cooling panel. Bent Pipes 26 and 28 are thus protected from the furnace interior inside their respective recess at the rear side of the cooling plate.

In addition, since the cooling is provided with individual/respective recesses 32 for each coolant channel, two neighboring recesses are separated by a partition of body material. Hence, as compared to a stave comprising an entirely beveled side edge, body material remains in the side edge region, which is the cooling plate region where wearing off begins. These individual recesses 32 also tend to retain matter such as guniting concrete or blast furnace burden material; accumulation of such matter in the individual recesses will protect the bent tubes (at the connection with the cooling plate) from heat and abrasion.

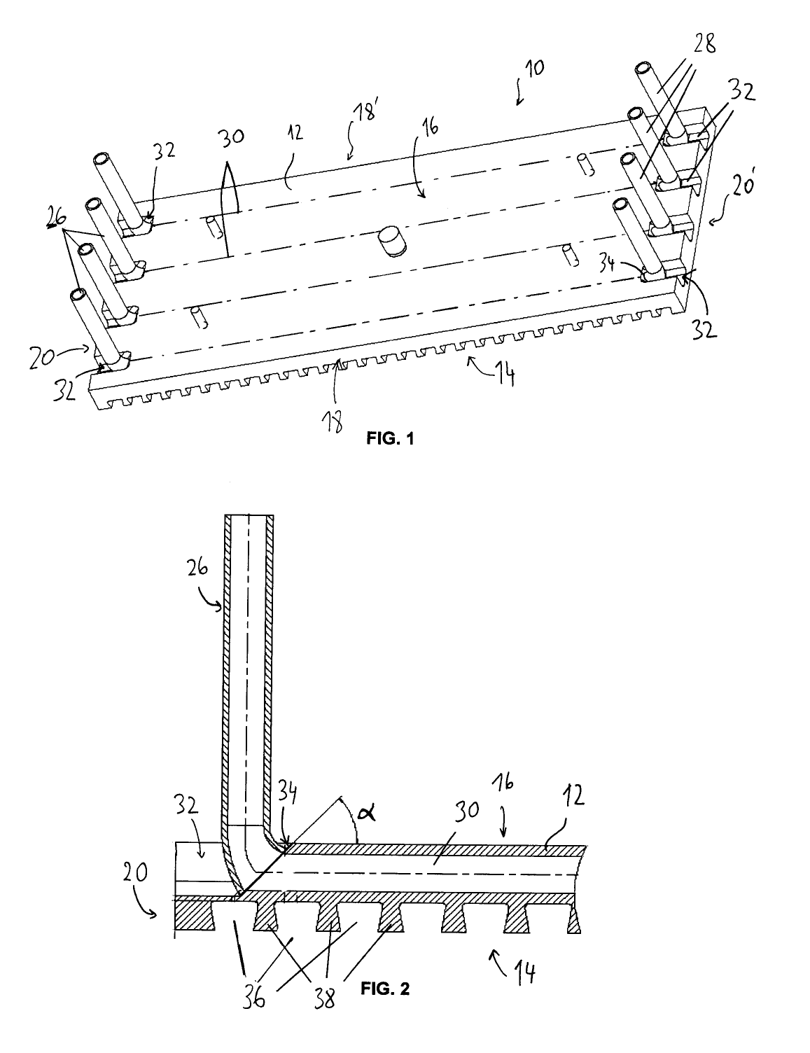

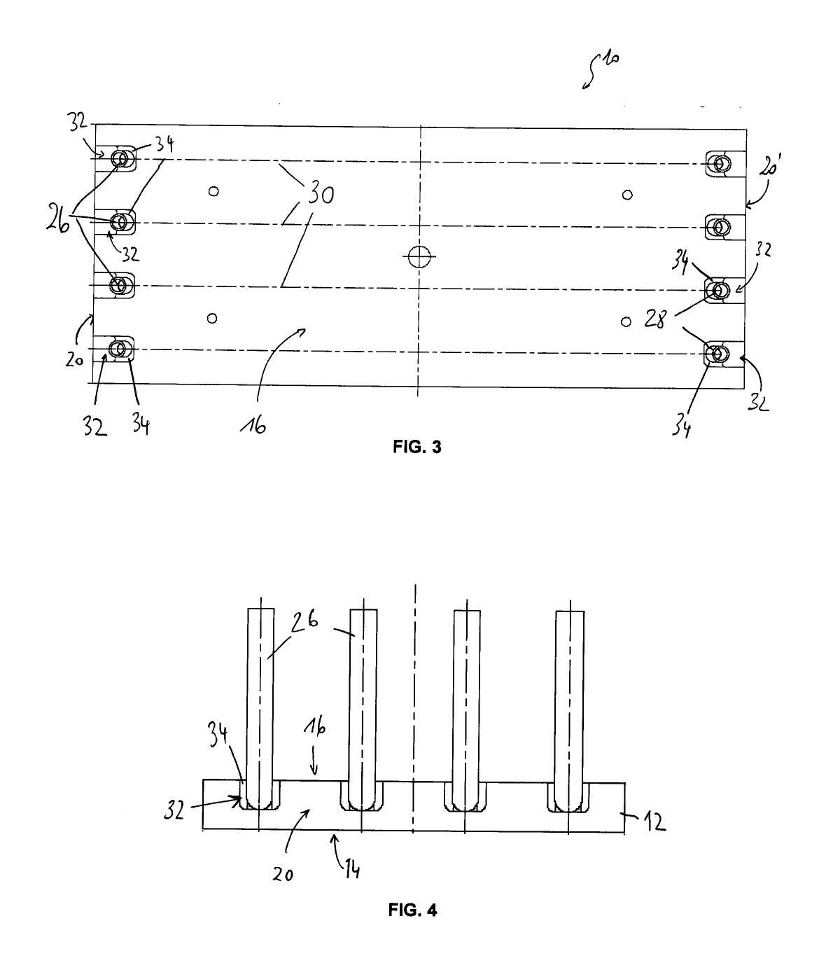

Referring further to FIGS. 1 and 2, it will be noted that the front face 14 is subdivided by means of grooves 36 into lamellar ribs 38. The grooves 36, laterally delimiting the lamellar ribs 38, may be milled into the front face 14 of the panel-like body 12. The lamellar ribs 38 extend parallel to the first and second edges 20, 20′, from a first long edge 18 to the opposite long edge 18′ of the panel-like body 12. They are perpendicular to the cooling channels 30 in the panel-like body 12. When the cooling plate 10 is mounted in the furnace, the grooves 36 and lamellar ribs 38 are arranged horizontally. They form anchorage means for anchoring a refractory brick lining, a refractory guniting or a process generated accretion layer to the front face 14.

In order to warrant an excellent anchoring for a refractory brick lining, a refractory guniting material or a process formed accretion layer to the front face 14, it should be noted that the grooves 36 advantageously have a dovetail (or swallowtail) cross-section, i.e. the inlet width of a groove 36 is narrower than the width at its base. The mean width of a lamellar rib 38 is preferably smaller than the mean width of a groove 36. Typical values for the mean width of a groove 36 are e.g. in the range of 40 mm to 100 mm. Typical values for the mean width of a lamellar rib 38 are e.g. in the range of 20 mm to 40 mm. The height of the lamellar ribs 38 (which corresponds to the depth of the grooves 36) represents generally between 20% and 40% of the total thickness of the panel-like body 12.

One preferred method of manufacturing the present cooling plate 10 will now be described. A copper or copper alloy slab is manufactured by continuous casting. A plurality of boreholes are then formed in the obtained plate body by mechanical deep-drilling from one short side towards the opposite one in order to form the coolant channels. It may be noted that the holes may be through holes or bore holes ending in the region of the opposite side edge. Optionally, the body may subsequently be subjected to a rolling step so as to form coolant channels with oblong cross-section.

Next, the front face 14 structure is preferably formed by milling so as to form the grooves 36 and intermittent lamellar ribs 38.

Finally, the body 12 is processed/machined so that the extremity of each coolant channel opens into a respective recess 32, the channel opening itself being flush with a connection surface 34. Such recess may typically be formed by milling the body from the rear side in axial continuation of the coolant channel. In the present embodiment the recess is open toward the respective side edge 20 or 20′. However a possible alternative is to simply mill the recess in the rear side without extending it to the side edge, but allowing sufficient room to install and connect the connection tube.

Then the connection pipes 26 and 28 are sealingly connected to the respective extremities of the coolant channels within the recesses. This may be done by welding or soldering. Where desired, a centering sink (not shown) surrounding the channel opening may be provided in the connection surface.

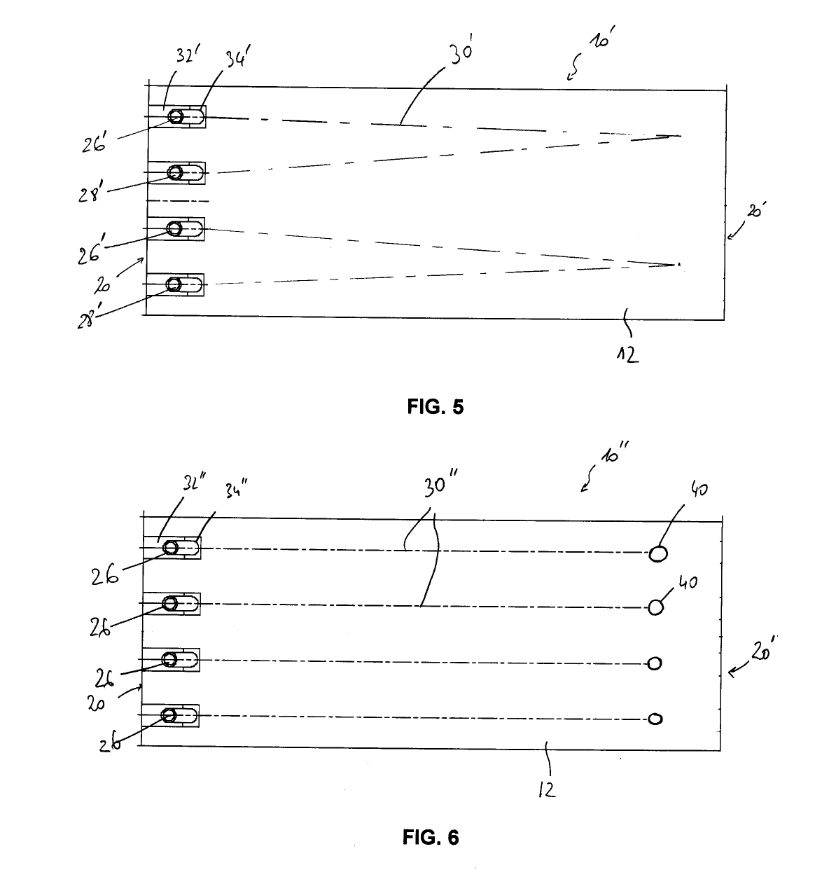

FIG. 5 illustrates another embodiment, wherein the cooling plate 10′ comprises connection pipes 26′ and 28′ on one side edge only. The coolant channels, represented by the mixed line 30′, have a V-shaped configuration. They are obtained by drilling two blind boreholes from the same side edge 20 so that these blind holes meet in the region of the opposite side edge 20′. The bent pipes 26 and 28 are connected to the coolant channels 30′ inside respective recesses 32′ where the coolant channels 30′ open in a beveled connection surface 34′, as described above.

Still a further embodiment is shown in FIG. 6, wherein the cooling plate 10″ comprises a plurality of transversal coolant channels 30″ provided with connection pieces in the regions of the both side edges. In this embodiment, the coolant channels 30″ are formed by drilling blind boreholes from the first side edge 20. In the first side edge region (i.e. from which the drill bit entered the body), the coolant channels open in a beveled connection surface 34″ of a respective recess 32″. In the region of the opposite side edge 20′, a connecting bore 40 is drilled from the rear face 16 to provide fluid communication with the coolant channel, and a straight connecting pipe (not shown) is sealingly fixed to the rear side in fluid continuation of the bore 40.

1. A method for manufacturing a cooling plate for a metallurgical furnace comprising the steps of:
providing a slab body of metallic material, said body having a front face, an opposite rear face and four side edges, wherein said body has at least one coolant channel therein;
machining said body so that at least one extremity of each coolant channel opens in a connection surface inside a respective recess open toward said rear face, said connection surface being beveled toward said rear face; and
sealingly connecting a bent connection pipe with an extremity of said coolant channel in said recess, wherein said bent connection pipe does not extend laterally beyond said side edge.

2. The method according to claim 1, wherein said at least one coolant channel is formed in said body by drilling at least one borehole into said body from a first side edge toward an opposite, second side edge.

3. The method according to claim 1, wherein each connection pipe is soldered or welded around the corresponding coolant channel opening in the respective connection surface.

4. The method according to claim 1, wherein the angle between said beveled connection surface and the rear face is between 20° and 70°.

5. The method according to claim 1, wherein said slab body is a forged, cast or rolled slab.

6. The method according to claim 1, wherein said slab body is a continuously cast metal slab with at least one cast-in coolant channel.

7. A cooling plate for a metallurgical furnace comprising a body with a front face, an opposite rear face, four side edges and at least one coolant channel extending from the region of one side edge to the region of the opposite side edge;
a bent connection pipe connecting at least one extremity of each coolant channel for coolant fluid feed or return;
wherein
said bent connection pipe is sealingly connected with an extremity of the associated coolant channel within a respective recess in said body that is opened toward the rear face, said coolant channel opening in said recess in a connection surface beveled towards the rear face; and
said bent connection pipe does not extend laterally beyond the corresponding side edge.

8. The cooling plate according to claim 7, wherein said beveled connection surface forms and angle of between 20° and 70° with respect to the rear side of said cooling plate.

9. The cooling plate according to claim 7, wherein each extremity of said cooling channel opens into a respective recess where it is connected to a respective connection pipe.

10. The cooling plate according to claim 7, wherein each coolant channel has a circular or oblong cross-section.

11. The cooling plate according to claim 7, wherein the coolant channels are configured so that the bent connection pipes are situated on the same side edge.

12. The cooling plate according to claim 7, wherein each coolant channel opens in the region of a first side edge in the connection surface of a respective recess, where it is connected to a bent connection pipe; and in the region of the opposite side edge, fluid communication is provided by a borehole drilled from the rear side.

13. The cooling plate according to claim 7, wherein said body comprises lamellar ribs on its front face.

14. The cooling plate according to claim 7, wherein the bend angle of said connection pipes is between 110° and 160°.

15. A metallurgical furnace comprising an outer shell, the inner wall of said outer shell being covered by cooling plates according to claim 7.

16. The cooling plate according to claim 8, wherein the bend angle of said connection pipes is between 110° and 160°.
